(19) United States
(12) Patent Application Publication
(10) Pub. No.: US 2017/0182691 A1
(43) Pub. Date: Jun. 29, 2017

(54) SIDE GATED HOT RUNNER WITH TEMPERATURE CONTROL AT THE TIPS

(71) Applicant: Otto Männer Innovation GmbH, Bahlingen (DE)

(72) Inventor: Swen Spuller, Forchheim (DE)

(21) Appl. No.: 14/980,788

(22) Filed: Dec. 28, 2015

(51) Int. Cl. B29C 45/74

(52) U.S. Cl. CPC B29C 45/74; B29L 2031/757

(57) ABSTRACT

A hot runner injection molding apparatus comprising an injection molding manifold having an inlet melt channel and a plurality of outlet melt channels and a plurality of hot runner nozzles coupled to the outlet melt channels. Each hot runner nozzle includes a nozzle body defining a first nozzle body melt channel having a first axis. A nozzle tip housing is coupled to the nozzle body which includes at least two auxiliary melt channel portions each auxiliary melt channel portion has a second axis which is angled with respect to the first axis. At least two nozzle tips are arranged at the nozzle tip housing and in the area of each nozzle tip a nozzle tip heater is arranged, which is oriented substantially along the first melt channel.

### TECHNICAL FIELD

This invention is related to a hot runner injection molding apparatus. More specifically, this invention is related to a side, or edge gating hot runner nozzle.

### BACKGROUND

Side or edge gating hot runner nozzles are known. The known concepts have shortcomings resulting from imbalances in heat distribution both in the apparatus and the melt.

A proper heat distribution is important for good functioning of a hot runner injection molding apparatus. Prior to manufacture, it is important, that all functional units of the apparatus have the necessary temperature as the design of the components is made with respect to the operating temperature of the apparatus. For example, only after the heating of the nozzle body and the respective thermal expansion, the nozzle tip fits sealing within the gate orifice. Accordingly, if the nozzle is not heated to the necessary temperature, leakage will occur.

Even more, due to manufacturing tolerances, there are areas where more heat is needed than in other areas, even of same components.

Therefore, there is a need for an improved control of the temperature within an injection molding apparatus.

### SUMMARY

The application proposes a hot runner injection molding apparatus comprising an injection molding manifold having an inlet melt channel and a plurality of outlet melt channels and a plurality of hot runner nozzles coupled to the outlet melt channels. Each hot runner nozzle includes a nozzle body defining a first nozzle body melt channel having a first axis. A nozzle tip housing is coupled to the nozzle body which includes at least two auxiliary melt channel portions each auxiliary melt channel portion has a second axis which is angled with respect to the first axis. At least two nozzle tips are arranged at the nozzle tip housing and in the area of each nozzle tip a nozzle tip heater is arranged, which is oriented substantially along the first melt channel.

In a further development, in the area of each nozzle tip heater of the hot runner injection molding apparatus, a thermocouple is arranged for controlling the heat output of the corresponding nozzle tip heater. This allows individual controlling of heat for each nozzle tip.

In a further development of the hot runner injection molding apparatus the nozzle tip heater transfers heat to the nozzle tips and to the melt channels. This allows heating of the nozzle tip area and the melt channels.

In a further development of the hot runner injection molding apparatus the nozzle tip housing includes at least one cutout which is arranged between two nozzle tips on the nozzle tip housing to lower the heat transfer in the area of the nozzle tip housing between the two nozzle tips. Thus the cutout assists the individual heat control at the nozzle tips. This provides a heat barrier between each tip to reduce the heat transfer between tips.

In a further development of the molding apparatus a heat enhancer is arranged within at least one cutout on the nozzle tip housing. The heat enhancer allows transfer of heat between two nozzle tip areas.

In a further development the molding apparatus comprises a plurality of mold cavities, wherein each mold cavity has at least one mold gate orifice. The mold cavity can have a mold core having a third axis that is parallel to the first axis.

In a further development, the nozzle body has a first main nozzle heater and a thermocouple. In particular separate heaters are provided for each nozzle tip separate thermocouples for each heater.

In a further development the molding apparatus comprises a controller to adjust the main nozzle body heater and each nozzle tip heater independently. This is in particular useful for the start-up of the injection and for full operation of the nozzle.

Further advantages, features and applications of the present invention will become apparent from the following detailed description taken in conjunction with the figures.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 shows a partial sectional view of a side gated hot runner apparatus according to an exemplary embodiment of the invention.

FIG. 2 shows a sectional view in another sectional plane of the exemplary side gated hot runner apparatus shown in FIG. 1.

FIG. 3 shows a partial sectional view of the exemplary hot runner apparatus in sectional plane III-III shown in FIG. 1.

FIG. 4 shows an exemplary injection assembly of the side gated hot runner apparatus according to the exemplary embodiment of the invention.

FIG. 5 shows a sectional view of the exemplary injection assembly in sectional plane V-V shown in FIG. 4.

FIG. 6 shows a spatial view of the exemplary injection assembly shown in FIGS. 4 and 5, with a 135°-segment cutout.

FIG. 7 shows a spatial view of the side gating hot runner nozzle of the exemplary side gated hot runner apparatus.

FIG. 8 shows a schematic view of an exemplary heat profile within the runners and cavities in an exemplary gate system.

FIGS. 9a, 9b and 9c show each a sectional view in the sectional planes A-A, B-B and C-C of the exemplary gate system shown in FIG. 8.

### DETAILED DESCRIPTION OF THE INVENTION

In the following detailed description, numerous specific details are set forth in order to provide a thorough understanding of the present invention. However, it will be clear to one skilled in the art when the present invention can be practiced without some or all of these specific details. In other instances, well-known features or processes may not be described in detail so as not to unnecessarily obscure the invention. In addition, like or identical reference numerals may be used to identify common or similar elements.

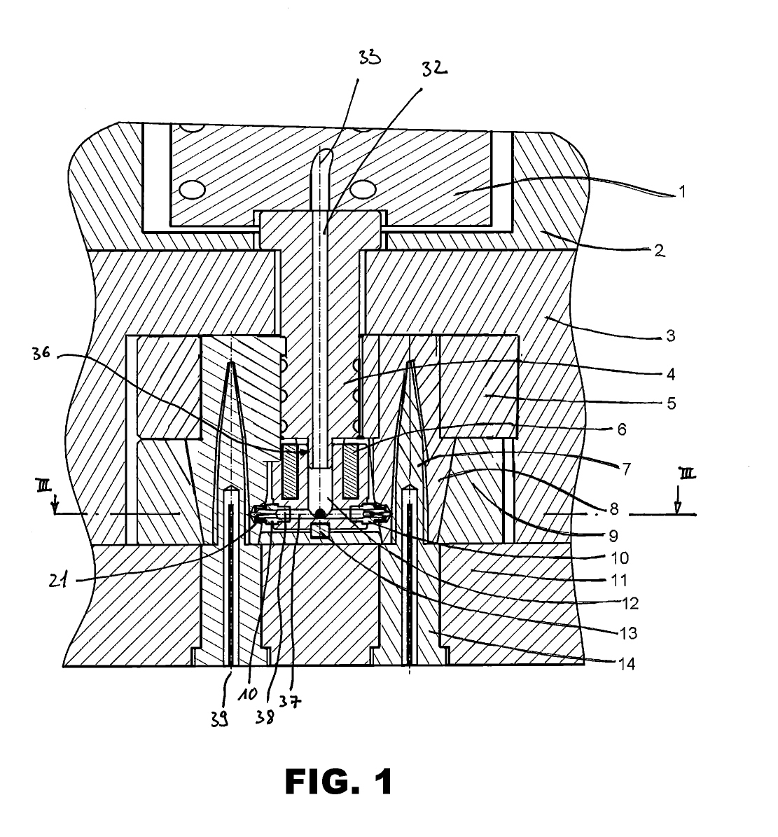

Reference is made to FIG. 1 which shows a partial view of an exemplary side gating or edge gating hot runner injection molding apparatus in accordance with an exemplary embodiment of the present invention. The apparatus includes a manifold 1 which is located within a first mold plate 2 and a plurality of hot runner nozzles 30 for providing melt to at least two separate molding cavities 15. In FIG. 1, only one side gated hot runner is shown.

Each hot runner nozzle 30 comprises a nozzle body 4 which in one axial direction of the nozzle body 4 fits at the manifold 1 in a way to allow molten material to flow from the outlet melt channel 22 into the first melt channel 32 disposed along a first axis 33 in the nozzle body 4 of the hot runner nozzle 30. In the opposite axial direction the nozzle body 4 penetrates the first mold plate 2 and is supported with its flange at the second mold plate 3.

Each hot runner nozzle 30 further includes a separate and removable nozzle tip housing 12 that is coupled to the nozzle body 4 via a sliding connector element 36 that provides for an axial movement of the nozzle tip housing 12 or of the nozzle body 4 to avoid any difficulties due to thermal expansion and to allow the disassembly of nozzle tip housing 12 and nozzle body 4.

Each nozzle tip housing 12 retains at least two nozzle tips 10 which are arranged in lateral openings of the nozzle tip housing 12. The number of nozzle tips 10 arranged at the nozzle tip housing is not limited to two nozzle tips 10. Depending on the size of the nozzle tip housing 12 and the nozzle tips 10, there can be 4, 6, 8, 10, 12 or even more nozzle tips 10 arranged in lateral openings at the nozzle tip housing 12. It is also possible to arrange an uneven number of nozzle tips 10 at the nozzle tip housing 12 as for example 3, 5, 7, 9 or more nozzle tips 10. The nozzle tips 10 extend partially outside of the outer surface of the nozzle tip housing 12.

As shown in FIGS. 1, 3 and 6, the nozzle body 4 makes a sealing contact with the manifold 1 and a sealing contact with molding cavity inserts 8 provided by nozzle tips 10 and nozzle seal elements 21.

FIG. 1 further shows two auxiliary melt channel portions 37 of the nozzle tip housing 12. The auxiliary melt channel portions 37 are disposed along a second axis 38 which is angled with respect to the first axis 33. Injection molding cavities 15 are disposed in removable arranged molding cavity inserts 8. A mold core 7 is disposed within the molding cavity 15. In the shown embodiment, for disassembling the injection molding apparatus, the molding cavity inserts 8 are removable together with the nozzle tip housing 12 and the nozzle tips 10 while the nozzle body 4 stays supported with its flange at the second mold plate 3 and thus unaffected in the initial operation position in the mold plates 2, 3 within the injection molding apparatus.

The injection molding cavities 15 are positioned along a third axis which here is parallel to the first axis 33. The lateral wall of a mold insert 8 includes a mold gate orifice 57 which is positioned adjacent a nozzle tip 10. Each nozzle tip 10 is surrounded by a nozzle seal element 21. The lateral wall section receives and locates the nozzle seal element 21 which serves for sealing the nozzle at the sealing section.

In FIG. 1, for each of the nozzle tips 10 a nozzle tip heater 6 is shown, which is oriented along the melt channel 32 of the hot runner nozzle 30 and thus oriented substantially in the direction of the first axis 33. Each nozzle tip heater 6 serves for heating of one nozzle tip 10 and also serves for heating the melt in the melt channel 32. The heat output of each nozzle tip heater 6 is determined by a separate thermocouple (not shown in FIG. 1). In FIG. 1 also a nozzle tip holder support 13 is shown, which serves for supporting the nozzle tip in axial direction of the hot runner nozzle 30 and for centering the nozzle tip holder 6 with respect to the first axis 33 of the hot runner nozzle 30 and cavity inserts 8, respectively.

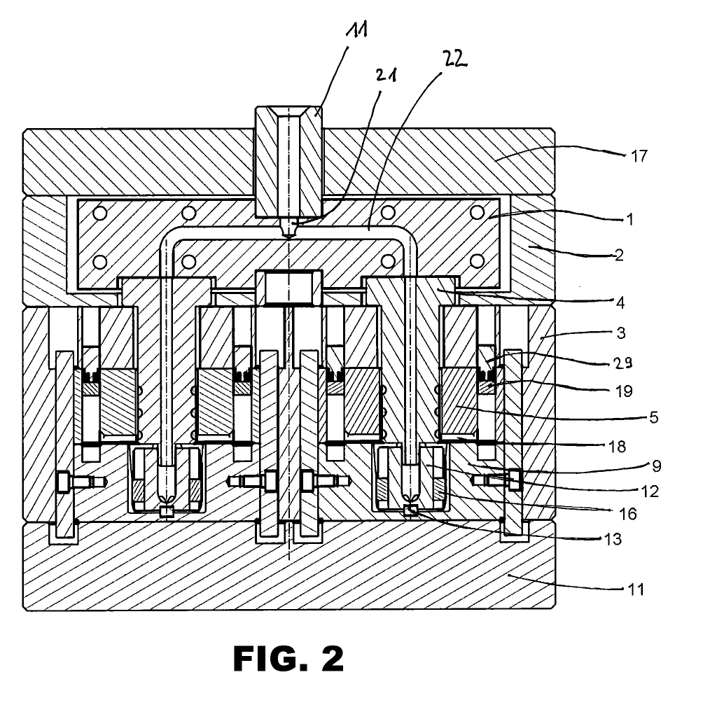

As shown in FIG. 2, molten material (melt) flows from the machine nozzle 11, which penetrates the machine plate 17, into the inlet melt channel 21 and through the outlet melt channels 22 of the manifold 1, through first melt channel 32 of the hot runner nozzle, and into molding cavities 15 in molding cavity inserts 8.

The exemplary injection molding apparatus comprises at least one injection assembly 70 which comprises at least one upper assembly element 5 and a lower assembly element 9 which are designed to retain at least one mold cavity insert 8 and the nozzle tip housing 12. In FIG. 2, two injection assemblies 70 are shown. In FIG. 2, for each injection assembly 70 two openings are shown, within which a removable molding cavity insert 8 is received. Due to the design of the exemplary injection molding apparatus, the injection assembly 70 also serves for the removal of the nozzle tip housing 12 and the nozzle tips 10 together with the upper and lower assembly elements 5, 9 and the corresponding molding cavity inserts 8.

The nozzle body 4 of the hot runner nozzle 30 is located in a first fix position with respect to the manifold 1 and the nozzle tip retainer 12 of the hot runner nozzle 30 is located in a second fix lower position by the nozzle tips 10 and seal elements 21 connected to the nozzle tip housing 12. In case of an axial thermal expansion the nozzle tips 10 and nozzle seal elements 21, the nozzle 30 may be damaged due to a high stress. For this reason and to avoid problems the nozzle 30 is split in two parts that slide relative to the other, as is shown in FIG. 1 and FIG. 2. One part is the nozzle body 4 and the other part is the nozzle tip housing 12 that retains the nozzle tips 10 and nozzle seal elements 21.

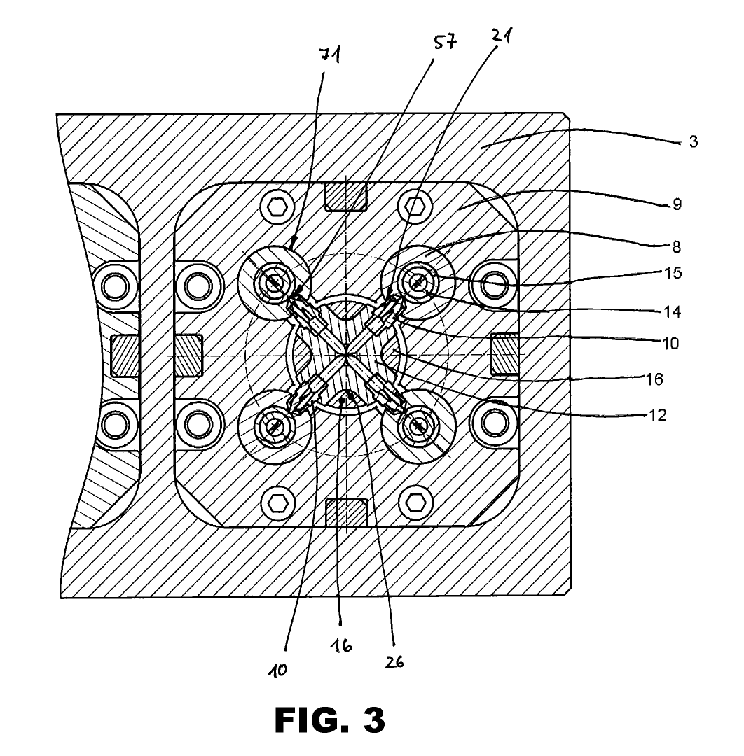

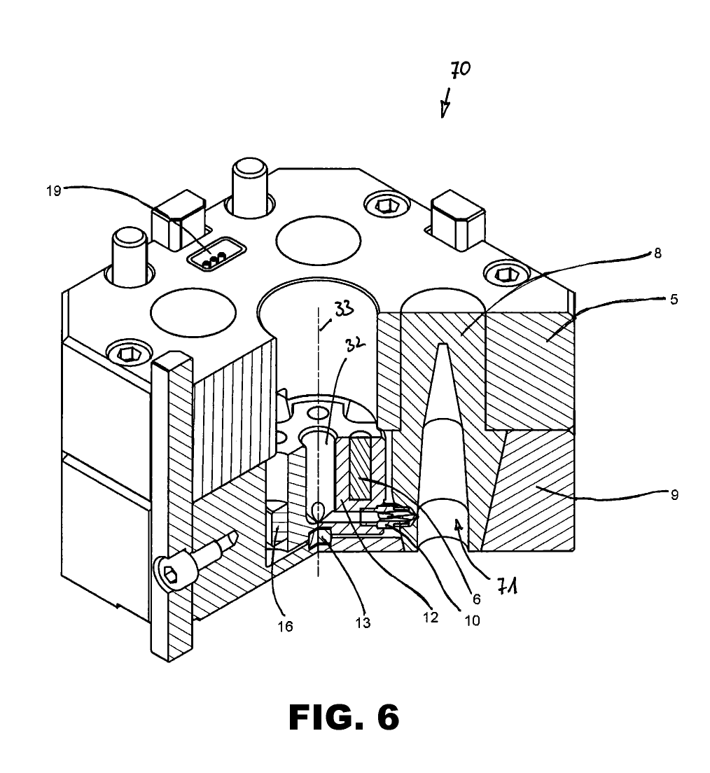

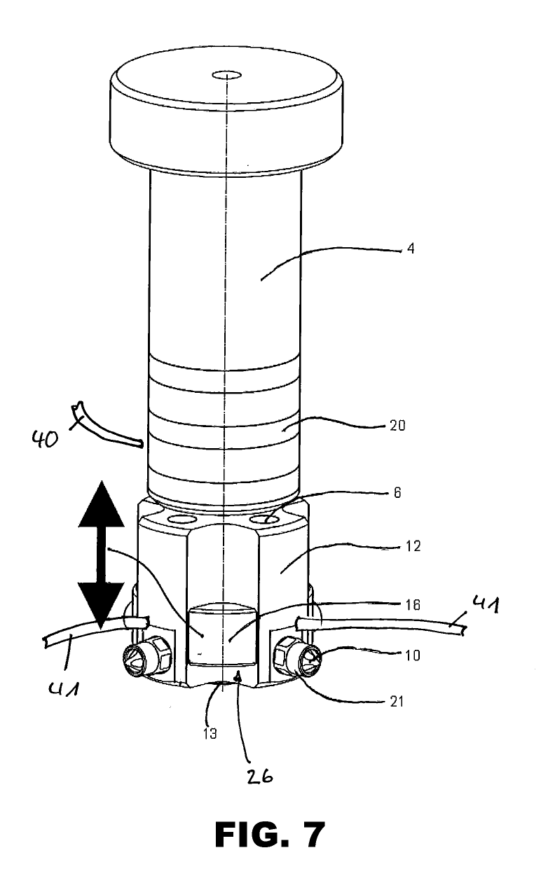

FIG. 3 shows a partial cross sectional view in section plane III-III of the hot runner apparatus shown in FIG. 1. The same reference numerals designate the same elements as in FIGS. 1 and 2. The injection assembly 70 is disposed within the second mold plate 3. The injection assembly 70 comprises four openings 71 evenly distributed around the nozzle tip housing 12 within which molding cavity inserts 8 are received. Also the nozzle tip housing 12 comprises four nozzle tips 10 which are evenly distributed around the nozzle tip housing 12. Also evenly distributed around the nozzle tip housing 12 and in each case disposed between two nozzle tips 10, cutouts 26 serve as thermal barrier between two nozzle tips. As better visible in FIGS. 6 and 7, heat enhancer elements 16 can be arranged within this cutouts 26 which are moveable along the cutout 26 to enhance the conduction of heat within the nozzle tip housing 12 if needed according to the design or process of the molded product.

If a nozzle tip 10 or nozzle seal element 21 is damaged and needs to be removed from the nozzle 30, the invention provides a modular design approach. The two parts nozzle 30 provide for the nozzle body 4 to be located in a fix position relative to the manifold 1 and a mold plate 3 while allowing the nozzle tip housing 12 to be removed from the front side when the mold is in a stationary open position for servicing. As is shown in the Figures, the modular system comprises several injection assemblys 70 that include at least two openings 71 to locate at least two molding cavity inserts 8 in a tight, yet removable way. In FIG. 6 there is a 3D view of an injection assembly 70 having four openings 71 to locate four molding cavity inserts 8 in conjunction and cooperation with four mold cores 14.

This injection assembly 70 comprises at least one upper assembly element 5 and a lower assembly element 9, several molding cavity inserts 8, a single nozzle tip housing 12 having at least two nozzle tips 10 and nozzle seal elements 21. With moving the plate 11 to the bottom side in FIG. 1, the injection assembly 70 allows the assembly, disassembly and service of the injection molding apparatus even though the nozzle tips 10 and nozzle seal elements 21 are locked into openings of the mold cavity inserts 8.

After the injection assembly 70 is removed from the corresponding mold plate 3, the lower assembly element 9, the nozzle tip housing 12 with the tips 10 and nozzle seal elements 21 can be removed. After that the molding cavity inserts 8 can be released from the nozzle tip housing 12 and nozzle tips 10 by lateral sliding. Next, the nozzle seal elements 21 and the nozzle tips 10 can be removed. The same steps but in reverse are used to assembly or to put back the nozzle head and the nozzle tips 10 in sealing contact with the mold gate orifices 57.

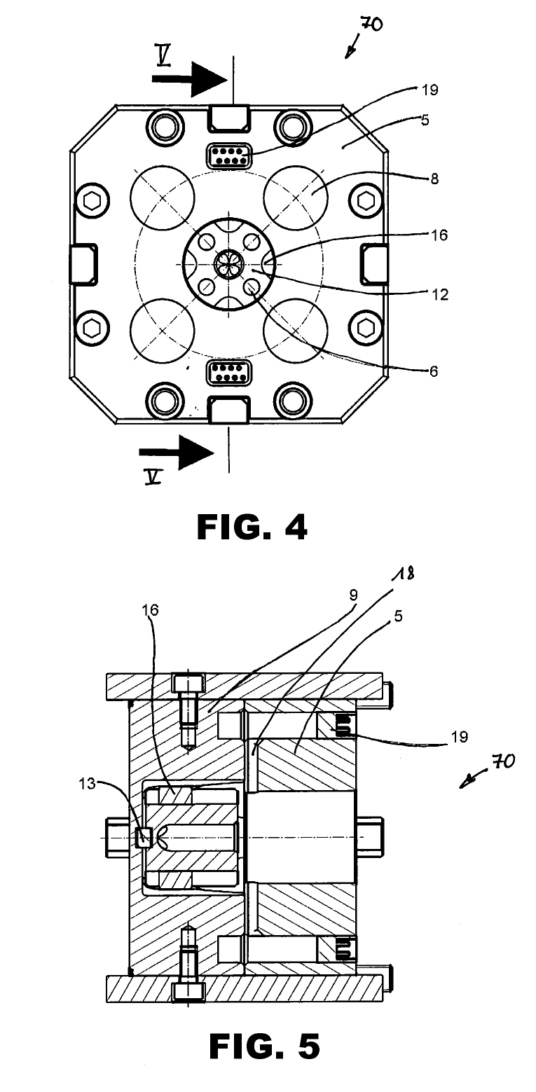

FIG. 4 shows an exemplary injection assembly 70 of the side gated hot runner apparatus according to the exemplary embodiment of the invention. In the center of the assembly 70 the nozzle tip housing 12 is arranged. The nozzle tip accommodates four nozzle tips and the injection assembly 70 accommodates four corresponding mold cavity inserts 8. The position of the four separate nozzle tip heaters 6 can be seen in FIG. 4. Also visible in this view are two connectors 19 for connecting the nozzle tip heaters 6 to electric power supply with a second connecting element 29. The use of connectors 19 allows an easy assembly and disassembly of the injection assembly 70. The connectors can also serve to connect not shown thermocouples, which are also arranged in the nozzle tip housing 12 and injections assembly 70, respectively.

FIG. 5 shows a sectional view of the exemplary injection assembly 70 in sectional plane V-V shown in FIG. 4. In this view, wiring space 18 can be seen, which serves as space for positioning the wiring of the nozzle tip heaters 6 and the wiring of thermocouples between the nozzle tip housing 12 and the connector 19. In FIG. 5, heat enhancers 16 are arranged at a position near to the nozzle tip to improve the heat transfer between nozzle tips 10 arranged side by side.

FIG. 6 shows a spatial view of the exemplary injection assembly 70 shown in FIGS. 4 and 5, with a 135°-segment cutout. The position of the nozzle tip heaters 6 along the melt channel 32 and into close proximity of the nozzle tip 10 can be seen. It is also possible to arrange the nozzle tip heaters 6 more close or more distant to the melt channel 32 or to the nozzle tip 10. It is also possible to use other types of nozzle tip heaters as the cartridge heaters shown in this exemplary embodiment.

FIG. 7 shows a spatial view of the hot runner nozzle 30 of the exemplary side gated hot runner apparatus. A nozzle body heater 20 encircles the nozzle body 4. At an external position of the nozzle body, a nozzle body thermocouple 40 is arranged within the injection molding apparatus. The nozzle body thermocouple 40 determines the temperature in the area of the nozzle body heater 20 and serves for controlling the heat output of the nozzle body heater 20. In FIG. 7 also the position of the nozzle tip heaters 6 within the nozzle tip housing 12 is shown. Also in the area of each nozzle tip heater 6 a nozzle tip thermocouple 41 is arranged. The nozzle tip thermocouples 41 determine the temperature in the area respectively one nozzle tip heater 6 and serve for controlling the heat output of the corresponding nozzle tip heater 6.

As is indicated by the arrow, each heat enhancer 26 can be adjusted in axial direction to determine the position of enhanced heat conduction. Depending on the design of the molded part and the process, it is also possible, that no heat enhancer 26 is used. Generally, the heat transfer between to nozzle tips 10 arranged side by side in the nozzle tip housing 12 rather needs to be avoided.

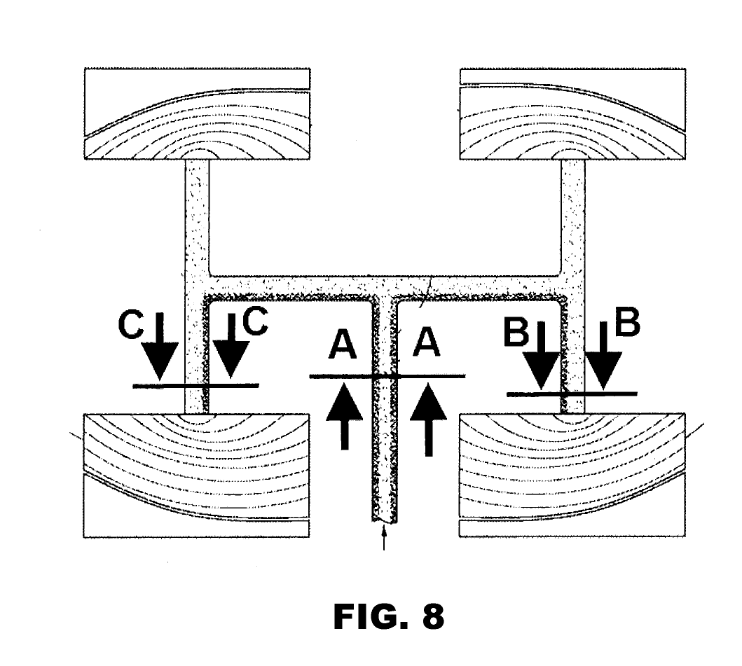

FIG. 8 shows a schematic view of an exemplary heat profile within the runners and cavities in an exemplary gate system. In FIG. 8 the imbalance of the heat distribution in a manifold and a hot runner, respectively is shown. As can be seen, an imbalanced heat distribution in one runner (A-A) continues after a branching of the channel and thus lead to an uneven form filling process.

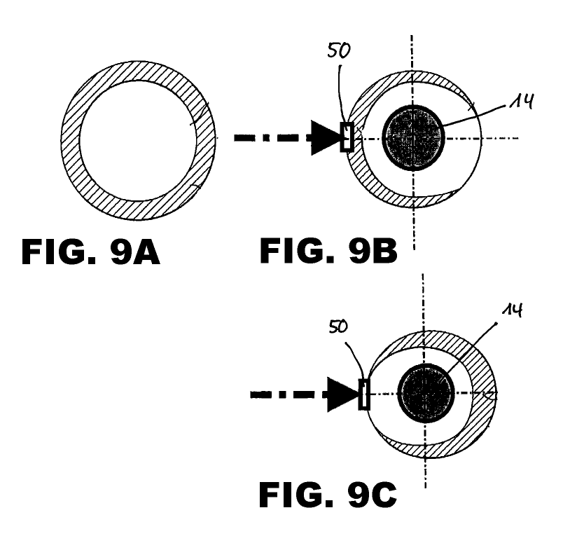

FIGS. 9a, 9b and 9c show each a sectional view in the sectional planes A-A, B-B and C-C of the exemplary gate system shown in FIG. 8. In the channel of FIG. 9a (A-A in FIG. 8), the heat is evenly balanced with different temperatures at the wall of the channel and the center of the channel.

FIGS. 9b and 9c show a situation, when a melt with uneven temperature distribution flows into a cavity through gate 50. According to the temperature distribution of the melt, melt with different temperature enters into the cavities, which can lead to deficiencies with form filling resulting in core shifting or incomplete molded parts.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the claims.

1. A hot runner injection molding apparatus comprising:
an injection molding manifold having an inlet melt channel and a plurality of outlet melt channels;
a plurality of hot runner nozzles coupled to the outlet melt channels, each hot runner nozzle including a nozzle body defining a first nozzle body melt channel having a first axis and a nozzle tip housing, wherein the nozzle tip housing is coupled to the nozzle body;
the nozzle tip housing includes at least two auxiliary melt channel portions, each auxiliary melt channel portion has a second axis which is angled with respect to the first axis;
at least two nozzle tips are arranged at the nozzle tip housing and in the area of each nozzle tip a nozzle tip heater is arranged, which is oriented substantially along the first melt channel; and
wherein in the area of each nozzle tip heater a thermocouple is arranged for controlling the heat output of the corresponding nozzle tip hearer.

2. (canceled)

3. A hot runner injection molding apparatus according to claim 1, characterized in that the nozzle tip heater transfers heat to the nozzle tips and to the melt channels.

4. A hot runner injection molding apparatus according to claim 1, characterized in that the nozzle tip housing includes at least one cutout arranged between two nozzle tips on the nozzle tip housing to lower the heat transfer in the area of the nozzle tip housing between the two nozzle tips.

5. A hot runner injection molding apparatus according to claim 4, characterized in that a heat enhancer is arranged within the at least one cutout.

6. A hot runner injection molding apparatus according to claim 1, further comprising a plurality of mold cavities, each mold cavity having at least one mold gate orifice, each mold cavity further having a mold core, the mold core having a third axis that is parallel to the first axis.

7. A hot runner injection molding apparatus according to claim 1, characterized in that the nozzle body has a first main nozzle heater and a thermocouple.

8. A hot runner injection molding apparatus according to claim 1, further comprising separate nozzle tip heaters for each nozzle tip and separate nozzle tip thermocouples for each nozzle tip heater.

9. A hot runner injection molding apparatus according to claim 1, further comprising a nozzle body heater.

10. A hot runner injection molding apparatus according to claim 9, further comprising a controller to adjust the nozzle body heater and each nozzle tip heater independently.
